(19) United States
(12) Patent Application Publication
(10) Pub. No.: US 2022/0059247 A1
(43) Pub. Date: Feb. 24, 2022

(54) CONTROL ROD SYSTEM FOR REACTOR APPLICATIONS

(71) Applicant: Battelle Energy Alliance, LLC, Idaho Falls, ID (US)

(72) Inventor: Anthony L. Crawford, Rigby, ID (US)

(21) Appl. No.: 17/399,910

(22) Filed: Aug. 11, 2021

Related U.S. Application Data
(60) Provisional application No. 63/066,985, filed on Aug. 18, 2020.

(51) Int. Cl. G21C 7/14; G21C 7/28

(52) U.S. Cl. CPC G21C 7/14; G21C 7/28

(57) ABSTRACT

A control rod drive system includes a drive assembly and a cage assembly operably coupled to the drive assembly. The cage assembly includes a plurality of drive rods operably engaged with a drive platform, a plurality of guide rods extending through the drive platform, and a control platform releasably coupled to the drive platform via quick release assembly, the control platform configured to have a control rod mounted thereto. A method of control operation of a nuclear reactor includes receiving instructions to adjust operation of the nuclear reactor, moving a control rod relative to a core of the nuclear reactor via rotating one or more drive rods engaged with a drive platform, and releasing a control platform coupled to the control rod from the drive platform.

### CROSS-REFERENCE TO RELATED APPLICATIONS

This application claims the benefit under 35 U.S.C. § 119(e) of U.S. Provisional Patent Application Ser. No. 63/066,985, filed Aug. 18, 2020, pending, the disclosure of which is hereby incorporated in its entirety herein by this reference.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

This disclosure relates generally to control rod drive systems for nuclear reactors (e.g., microreactors) and related methods.

### BACKGROUND

Nuclear reactors are generally large in size, and thus, flux control mechanisms (e.g., shutdown rods, control rods, control drums) of the reactors typically have extensive volumes to occupy. The extensive volumes allow the flux control mechanisms to be relatively long, which allows component accessibility and displacing sensitive parts from a reactor environment (flux and thermal). Furthermore, the large volumes allow supplementary shielding for radiation sensitive components (e.g., electrical components). However, microreactors do not provide the luxury of larger volumes or associated weight allowances for flux control mechanism. Therefore, the mechanisms are required to be more compact, while still providing an accessible and environment tolerant solution.

Microreactors have a relatively large number of applications, such as, for example, electric power generation, hydrogen production, etc. Microreactors are particularly useful in isolated environments. Several technologies are being developed to facilitate microreactors, and each of the technologies presents its own system requirements, including the mechanical control system's (e.g., a control rod drive system's) abilities to effectively function in a restricted volume (e.g., space), while also accommodating a wide range of conditions. Many conventional mechanical control systems are very specific to the nuclear reactor in question and lack flexibility to tune their functions to various desired performance features (e.g., motion response times, force requirements, shielding, etc.) of other systems.

### BRIEF SUMMARY

Some embodiments of the present disclosure include a control rod drive system. The control rod drive system may include a drive assembly and a cage assembly operably coupled to the drive assembly. The cage assembly may include drive rods operably engaged with a drive platform, guide rods extending through the drive platform, and a control platform releasably coupled to the drive platform via quick release assembly, the control platform configured to have a control rod mounted thereto.

One or more embodiments of the present disclosure include a nuclear reactor system. The nuclear reactor system may include a core, a plurality of control rods for inserting into and being retracted out of the core, and a plurality of control rod drive systems. Each of the control rod drive systems may include a drive assembly and a cage assembly operably coupled to the drive assembly. The cage assembly a plurality of drive rods operably engaged with a drive platform, a plurality of guide rods extending through the drive platform, and a control platform releasably coupled to the drive platform via quick release assembly, the control platform configured to have a respective control rod of the plurality of control rods mounted thereto.

Some embodiments of the present disclosure include a method of controlling operation of a nuclear reactor. The method may include receiving instructions to adjust operation of the nuclear reactor, moving a control rod relative to a core of the nuclear reactor via rotating one or more drive rods engaged with a drive platform, and releasing a control platform coupled to the control rod from the drive platform.

### BRIEF DESCRIPTION OF THE DRAWINGS

For a detailed understanding of the present disclosure, reference should be made to the following detailed description, taken in conjunction with the accompanying drawings, in which like elements have generally been designated with like numerals, and wherein:

FIG. 1 is a schematic view of a nuclear reactor system according to one or more embodiments of the disclosure;

FIG. 2A is a perspective view of a control drive system according to one or more embodiments of the disclosure;

FIG. 2B is a front side view of the control drive system of FIG. 2A;

FIG. 2C is another side view of the control drive system of FIG. 2A;

FIG. 2D is a side cross-sectional view of the control drive system of FIG. 2A;

FIG. 3 is a perspective view of a drive assembly and a portion of a cage assembly of the control rod drive system according to one or more embodiments of the disclosure;

FIG. 4A is a perspective view of a quick release assembly of a cage assembly of a control rod drive system according to one or more embodiments of the disclosure;

FIG. 4B is a perspective view of the quick release assembly of FIG. 4A with the drive platform removed to better show the structure of the quick release assembly;

FIG. 4C is a perspective view of the quick release assembly of FIG. 4A with one or more portions of the quick release assembly removed to better show the structure of the quick release assembly;

FIG. 5 is a flowchart of a method of controlling operation of a nuclear reactor; and

FIG. 6 is schematic diagram of a controller of a control rod drive system according to one or more embodiments of the present disclosure.

### DETAILED DESCRIPTION

The illustrations presented herein are not actual views of any control rod drive system or any component thereof, but are merely idealized representations, which are employed to describe the present invention.

As used herein, any relational term, such as “first,” “second,” “top,” “bottom,” “upper,” “lower,” “side,” etc., is used for clarity and convenience in understanding the disclosure and accompanying drawings, and does not connote or depend on any specific preference or order, except where the context clearly indicates otherwise. For example, these terms may refer to an orientation of elements of a control rod drive system when utilized in a conventional manner. Furthermore, these terms may refer to an orientation of elements of a control rod drive system when as illustrated in the drawings.

As used herein, the terms “comprising,” “including,” “containing,” “characterized by,” and grammatical equivalents thereof are inclusive or open-ended terms that do not exclude additional, un-recited elements or method steps, but also include the more restrictive terms “consisting of,” “consisting essentially of,” and grammatical equivalents thereof.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, the singular forms following “a,” “an,” and “the” are intended to include the plural forms as well, unless the context clearly indicates otherwise.

As used herein, the term “and/or” includes any and all combinations of one or more of the associated listed items.

As used herein, the term “substantially” in reference to a given parameter, property, or condition means and includes to a degree that one skilled in the art would understand that the given parameter, property, or condition is met with a small degree of variance, such as within acceptable manufacturing tolerances. For example, a parameter that is substantially met may be at least about 90% met, at least about 95% met, or even at least about 99% met.

As used herein, the term “about” used in reference to a given parameter is inclusive of the stated value and has the meaning dictated by the context (e.g., it includes the degree of error associated with measurement of the given parameter).

Embodiments of the disclosure include a control rod drive system having a cage assembly for controlling a position (e.g., linear position) of a control rod within a nuclear reactor (e.g., a microreactor). The cage assembly of the control rod drive system exhibits and enables both active flux control via motors and drive rods and passive reactor shutdown or control via a quick release assembly. Furthermore, the control drive system of the present disclosure may be relatively compact to meet space and weight requirements of a given system, accessible to enable easy maintenance and communication, thermally compatible with the given system, and flux compatible with the given system.

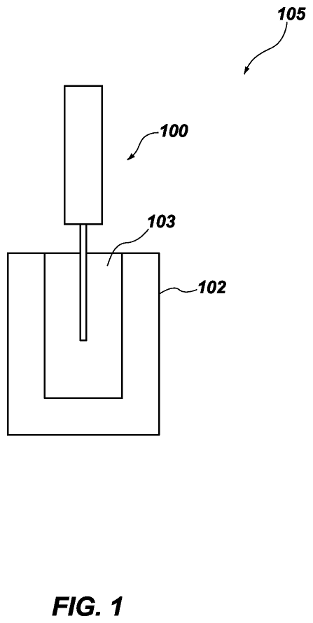

FIG. 1 is a schematic view of a nuclear reactor system 105 (e.g., a microreactor system) including a control drive system 100 and a nuclear reactor 102 (e.g., a microreactor). As is discussed in greater detail below, the control drive system 100 may be configured to adjust the position of a control rod within a core 103 of the nuclear reactor 102 to control the fission rate of a nuclear fuel (e.g., uranium or plutonium or other fuel) within the nuclear reactor 102. For instance, the control rod may include material compositions including one or more of boron, cadmium, silver, hafnium, or indium and may be capable of absorbing more neutrons than another material without itself fissioning. Additionally, the control drive system 100 may insert the control rod into and adjust a position of the control rod within (e.g., adjust an amount the control rod is inserted into) the nuclear reactor (e.g., core of the nuclear reactor) in order to control a rate of nuclear chain reaction and, thereby, one or more of thermal power output of the nuclear reactor 102, a rate of steam production, or an electrical power output of the nuclear reactor 102 (e.g., a nuclear power station). Embodiments of the disclosure include a nuclear reactor and a plurality of control drive systems 100 having respective control rods.

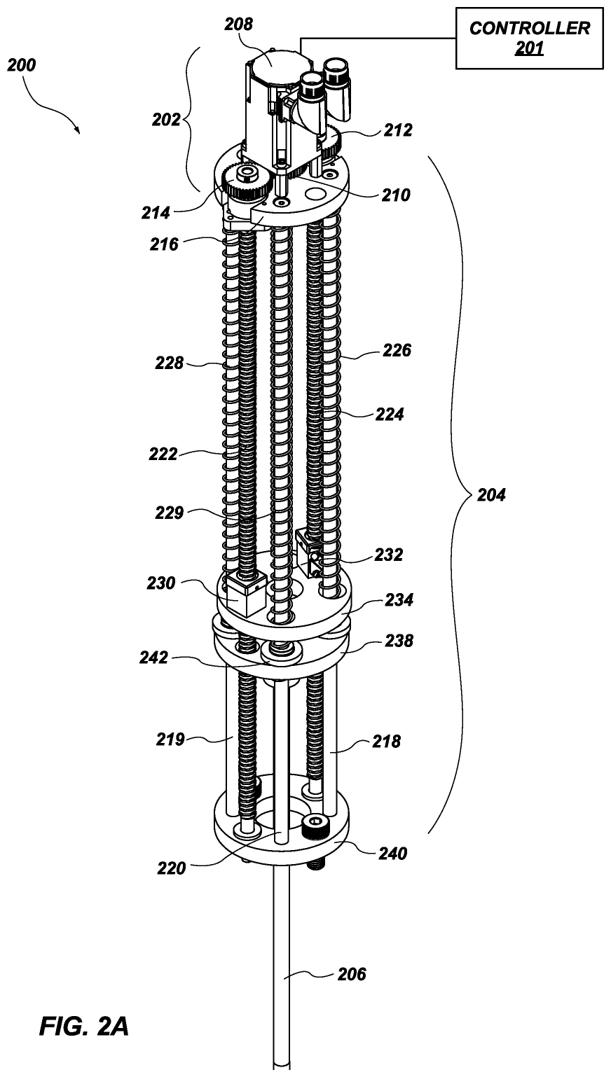

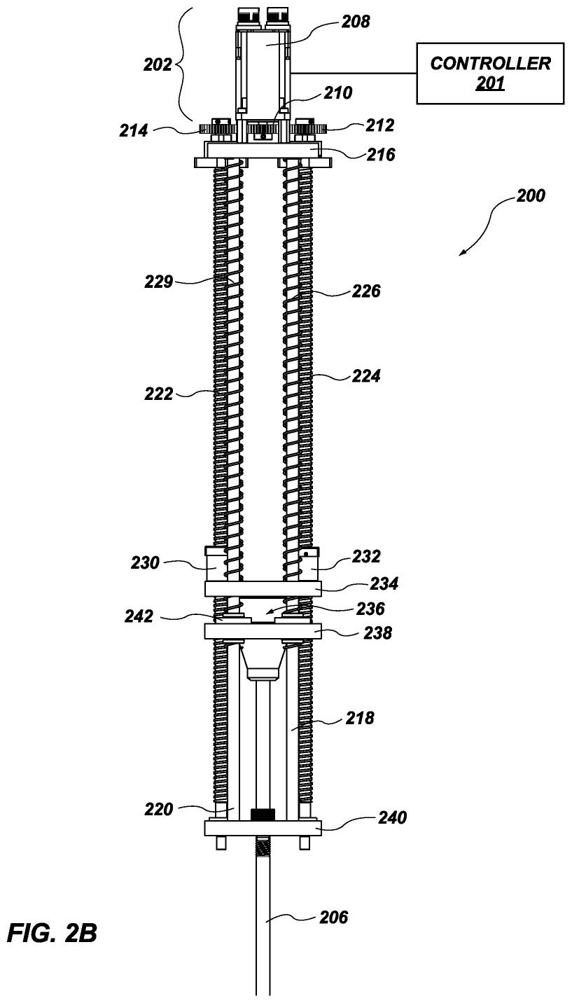

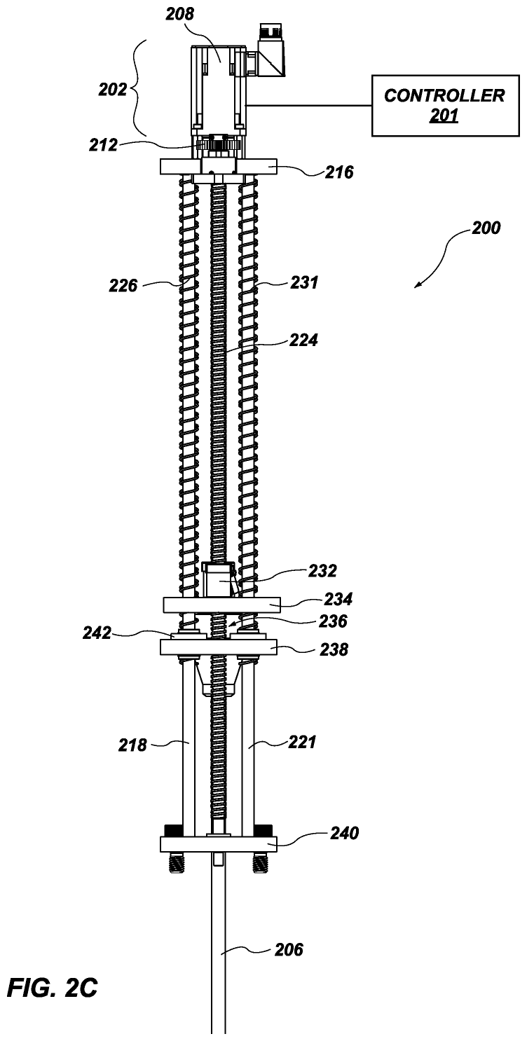

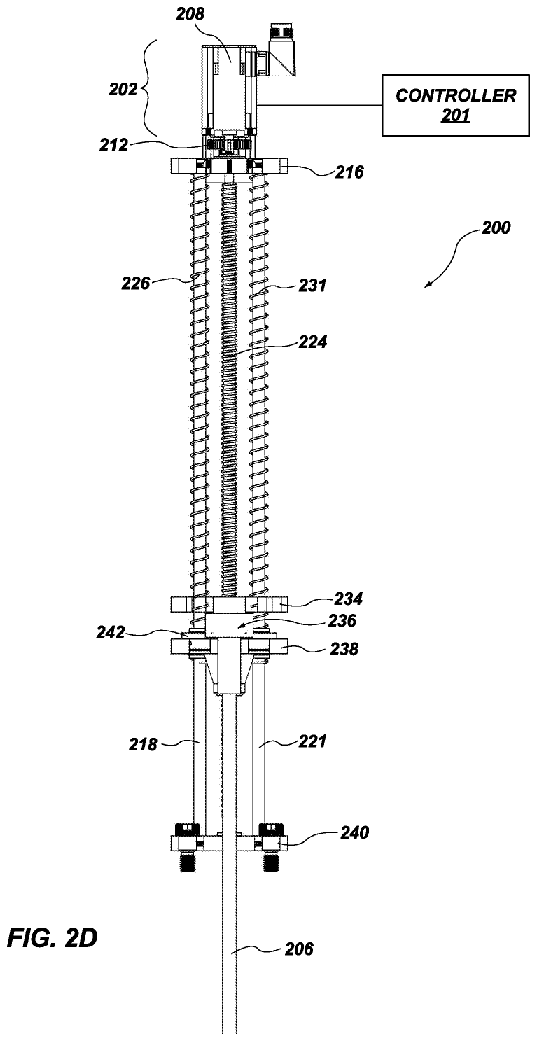

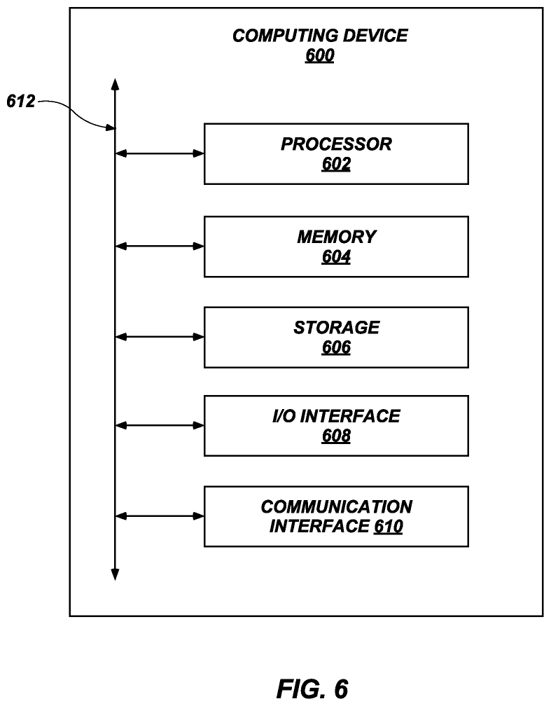

FIG. 2A is a perspective view of a control rod drive system 200 (e.g., control drive system 100) for controlling a position and orientation of a control rod of a reactor according to one or more embodiments of the disclosure. FIG. 2B is a front side view of the control rod drive system 200 of FIG. 2A. FIG. 2C is another side view of the control rod drive system 200 of FIG. 2A. FIG. 2D is a side cross-sectional view of the control rod drive system 200 of FIG. 2A. Referring to FIGS. 2A-2D together, the control rod drive system 200 may include a drive assembly 202, a cage assembly 204, and a control rod 206. The drive assembly 202 may be operably coupled to the cage assembly 204, and during use, the drive assembly 202 may operate (e.g., drive) one or more elements of the cage assembly 204 to control a position and/or orientation of the control rod 206 relative to a reactor (e.g., nuclear reactor 102). In other words, the drive assembly 202 may operate (e.g., drive) one or more elements of the cage assembly 204 to maneuver the control rod 206 relative to a reactor (e.g., nuclear reactor 102). Furthermore, the drive assembly 202 and/or the cage assembly 204 may operably be coupled to a controller 201, and the controller 201 may be utilized to control the drive assembly 202 and/or the cage assembly 204. Furthermore, the controller 201 may be, or may be in communication with, a controller of the nuclear reactor 102 and may receive data regarding reactor operation. The controller 201 is described in greater detail below in regard to FIG. 6.

The drive assembly 202 may include a motor 208, a drive gear 210 coupled to the motor 208, and two receiving gears 212, 214. The two receiving gears 212, 214 may be engaged with the drive gear 210, such that the drive gear 210 may impart rotational motion to the two receiving gears 212, 214. In some embodiments, the two receiving gears 212, 214 may be engaged with the drive gear 210 on opposite sides of the drive gear 210. Furthermore, the axes of rotation of the two receiving gears 212, 214 and the drive gear 210 may be at least substantially parallel to each other. As is described in greater detail below, the two receiving gears 212, 214 may be coupled to portions of the cage assembly 204 and, during operation, may impart rotational motion to the portions of the cage assembly 204.

The cage assembly 204 may include upper platform 216, at least one guide rod (referred to herein as “at least four guide rods” for clarity and consistency) 218, 219, 220, 221, at least two drive rods 222, 224, at least four drive springs 226, 228, 229, 231 at least two drive blocks 230, 232, a drive platform 234, a quick release assembly 236, a control platform 238, and a lower platform 240. The four guide rods 218, 219, 220, 221 and the two drive rods 222, 224 may be oriented at least substantially parallel to each other. The upper platform 216 may be coupled to upper longitudinal ends of the four guide rods 218, 219, 220, 221, and the upper longitudinal ends of the four guide rods 218, 219, 220, 221 may be fixed relative to the upper platform 216. The lower platform 240 may be coupled to lower longitudinal ends of the four guide rods 218, 219, 220, 221, and the lower longitudinal ends of the four guide rods 218, 219, 220, 221 may be fixed relative to the lower platform 240. Furthermore, the upper platform 216 and the lower platform 240 may be oriented at least substantially parallel to each other. Although the cage assembly 204 is described herein as including at least four guide rods, the disclosure is not so limited; rather, the cage assembly 204 may include a single guide rod (e.g., a single profiled guide rod) or two or more un-profiled rods). Furthermore, in some embodiments, the cage assembly 204 may include as many drive springs as guide rods, as is described in further detail below.

The drive platform 234 may be disposed between the upper platform 216 and the lower platform 240 and may be oriented at least substantially parallel to the upper and lower platforms 216, 240. The drive platform 234 may be free relative (e.g., free to translate) to the four guide rods 218, 219, 220, 221 and may be configured to translate (e.g., move) along the longitudinal lengths of the four guide rods 218, 219, 220, 221. For instance, in some embodiments, the drive platform 234 may include apertures through which the four guide rods 218, 219, 220, 221 may extend. Additionally, the four guide rods 218, 219, 220, 221 may serve as guides for motion of the drive platform 234, when the drive platform 234 is moving.

The two drive rods 222, 224 may each be coupled to a respective receiving gear (e.g., receiving gear of the two receiving gears 212, 214) of the drive assembly 202. For instance, each of the two receiving gears 212, 214 may include a sun gear and may be disposed about a circumference of a respective drive rod of the two drive rods 222, 224. Each of the two drive rods 222, 224 may be threaded. In some embodiments, both of the two drive rods 222, 224 may be threaded in a same direction. In additional embodiments, one of the two drive rods 222, 224 may be threaded in a first direction, and the other of the two drive rods 222, 224 may be threaded in a second, opposite direction. The two drive rods 222, 224 may extend from the upper platform 216 to the lower platform 240 and may be free to rotate relative to the upper and lower platforms 216, 240.

The two drive blocks 230, 232 may be fixed (e.g., coupled) to the drive platform 234, and each drive block of the two drive blocks 230, 232 may be engaged to (e.g., with) a respective drive rod of the two drive rods 222, 224. In some embodiments, each of the two drive blocks 230, 232 includes a threaded portion that may be threaded into a threaded aperture of the drive platform 234 to secure the two drive blocks 230, 232 to the drive platform 234. In other embodiments, the two drive blocks 230, 232 may be coupled to the drive platform 234 via any known fastener, weld, and/or adhesive. Each drive block of the two drive blocks 230, 232 may also include a threaded aperture extending therethrough and through which a respective drive rod of the two drive rods 222, 224 may extend and be engaged. Accordingly, when a drive rod of the two drive rods 222, 224 is rotated, a drive block of the two drive blocks 230, 232 coupled to the drive rod may be translated along (e.g., up and/or down) a longitudinal length of the drive rod. Additionally, because the two drive blocks 230, 232 may be fixed (e.g., coupled) to the drive platform 234, when the two drive rods 222, 224 are rotated, the drive platform 234 may be translated along (e.g., up and/or down) the longitudinal lengths of the two drive rods 222, 224.

The control platform 238 may be disposed between the drive platform 234 and the lower platform 240 and may be oriented at least substantially parallel to the drive and lower platforms 234, 240. The control platform 238 may be free relative (e.g., free to translate) to the four guide rods 218, 219, 220, 221 and the two drive rods 222, 224 and may be configured to translate along the longitudinal lengths of the four guide rods 218, 219, 220, 221. For instance, in some embodiments, the control platform 238 may include apertures through which the four guide rods 218, 219, 220, 221 may extend. Additionally, the four guide rods 218, 219, 220, 221 may serve as guides for motion of the control platform 238 during operation. The control rod 206 may be mounted to the control platform 238 such that motion of the control platform 238 results in a same motion of the control rod 206. For example, the control rod 206 may be mounted to a lower surface of the control platform 238. Furthermore, in some embodiments, the control rod 206 may extend through a central aperture of the lower platform 240.

In some embodiments, the cage assembly 204 may include bushings 242 disposed between the four guide rods 218, 219, 220, 221 and the control platform 238. As is described in greater detail below, in some embodiments, the bushings 242 may provide at least some friction between the four guide rods 218, 219, 220, 221 and the control platform 238 and may at least partially prevent or hinder motion of the control platform 238 relative to the four guide rods 218, 219, 220, 221. For example, the bushings 242 may enable creation of or may provide eddy brakes during relatively fast movement of the control platform 238 relative to the four guide rods 218, 219, 220, 221. Furthermore, the bushings 242 may at least substantially prevent or reduce horizontal movement of the control platform 238 or movement of the control platform 238 in a direction oblique or perpendicular to longitudinal axes of the four guide rods 218, 219, 220, 221. As is discussed in further detail below, at least substantially eliminating horizontal movement of the control platform 238 may enable more precise movement of the control rod 206 during operation. In some embodiments, the bushings 242 may comprise permanent magnets and/or electromagnets. Additionally, the bushings 242 may include stainless steel, aluminum, zirconium, or any alloys thereof. Furthermore, the bushings 242 may include plating such as lead plating for shielding.

In some embodiments, the control platform 238 may be separably coupled to the drive platform 234 via the quick release assembly 236. For instance, as is described in further detail below, in some embodiments, the quick release assembly 236 may include an electromagnet that can be quickly deactivated (e.g., de-energized) to release the control platform 238 from the drive platform 234. Regardless, when the control platform 238 is coupled to the drive platform 234, motion of the drive platform 234 results in substantially the same motion of the control platform 238. For instance, when the two drive rods 222, 224 are rotated, the control platform 238 may be translated along (e.g., up and/or down) the longitudinal lengths of the two drive rods 222, 224.

As noted above, the control rod 206 may be coupled to the control platform 238 such that motion of the control platform 238 results in substantially a same motion of the control rod 206. As a result, controlling motion of the drive platform 234 may control motion of the control platform 238 and the control rod 206. Therefore, when the two drive rods 222, 224 are rotated, the control rod 206 may be translated up and/or down relative to the core 103 of the nuclear reactor 102 to at least partially control an operation of the nuclear reactor 102.

The four drive springs 226, 228, 229, 231 may be coupled at lower longitudinal ends of the two drive springs 226, 228 to the control platform 238 and at upper longitudinal ends of the four drive springs 226, 228, 229, 231 to the upper platform 216. The four drive springs 226, 228, 229, 231 may be free relative to the drive platform 234. For instance, the four drive springs 226, 228, 229, 231 may extend through that same apertures through which the four guide rods 218, 219, 220, 221 extend. In some embodiments, each of the four drive springs 226, 228, 229, 231 may be disposed about a respective guide rod of the four guide rods 218, 219, 220, 221. For example, each of the four drive springs 226, 228, 229, 231 may extend circumferentially around a respective guide rod of the four guide rods 218, 219, 220, 221. Put another way, each of the four drive springs 226, 228, 229, 231 may be concentric with a respective guide rod of the four guide rods 218, 219, 220, 221. As is described in greater detail below, the four drive springs 226, 228, 229, 231 may enable a relatively quick movement of the control platform 238 and the control rod 206 (e.g., enable a relatively quick insertion of the control rod 206 into a reactor). For example, when the quick release assembly 236 decouples the control platform 238 from the drive platform 234, if the four drive springs 226, 228, 229, 231 are compressed, the four drive springs 226, 228, 229, 231 may extend (e.g., expand) and push the control platform 238 away from the upper platform 216 and may relatively quickly insert the control rod 206 into a reactor. Furthermore, when the quick release assembly 236 decouples the control platform 238 from the drive platform 234, in some embodiments, the quick release assembly 236 enables gravity to pull the control rod 206 into the core 103 of the nuclear reactor 102 relatively fast. For example, as is discussed in greater detail below, the four drive springs 226, 228, 229, 231 and the quick release assembly 236 may be used in conjunction for a relatively quick shut down procedure for the reactor.

Any of the elements of the control drive system 100 may include stainless steel, aluminum, zirconium, or any alloys thereof. Furthermore, any of the elements of the control drive system 100 may include plating or portions including lead for shielding. Moreover, the elements of the control drive system 100 may provide shielding for the motor 208.

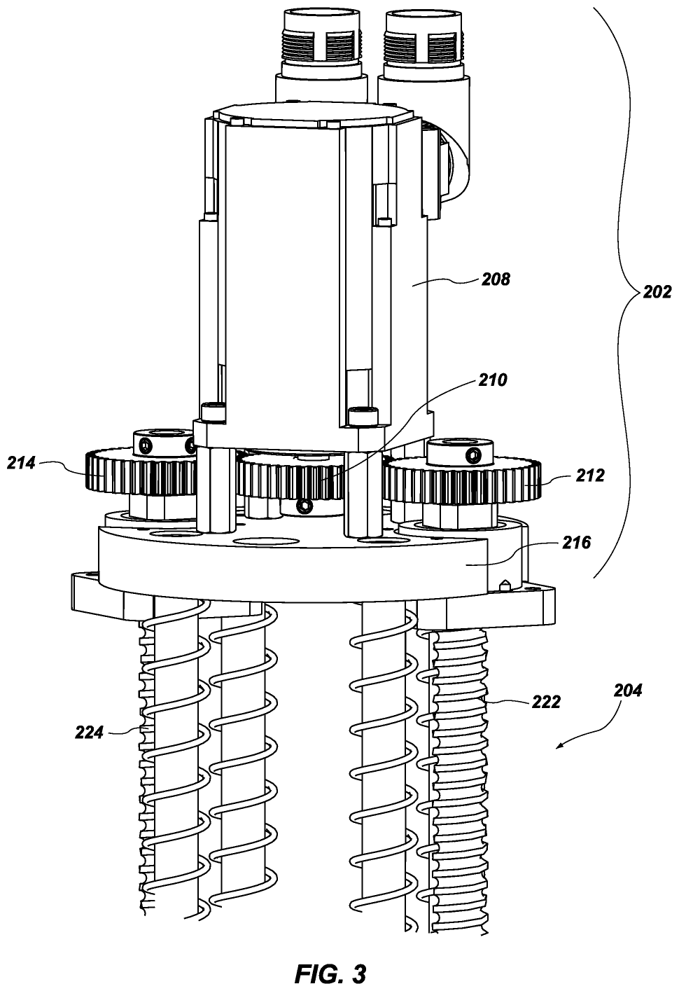

FIG. 3 is a perspective view of the drive assembly 202 and a portion of the cage assembly 204 of the control rod drive system 200. As described above, drive assembly 202 may include the motor 208, the drive gear 210 coupled to the motor 208, and the two receiving gears 212, 214. The two receiving gears 212, 214 may be engaged with the drive gear 210, such that the drive gear 210 may impart rotational motion to the two receiving gears 212, 214. The two receiving gears 212, 214 may be coupled to drive rods 222, 224 of the cage assembly 204 and, during operation, may impart rotational motion to the drive rods 222, 224 of the cage assembly 204. While the drive assembly 202 is described herein as including a drive gear 210 and two separate receiving gears 212, 214, the disclosure is not so limited. Rather, in some embodiments, the gears coupled to the drive rods 222, 224 or the drive rods 222, 224 themselves may be directly coupled to the motor 208. Furthermore, the drive assembly 202 may include a plurality of motors each coupled to a respective drive rod.

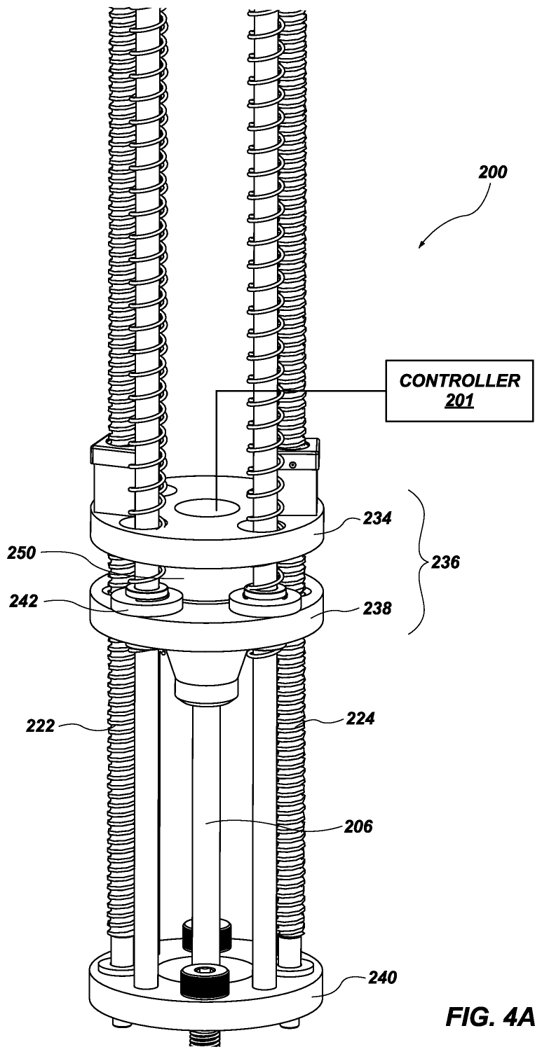

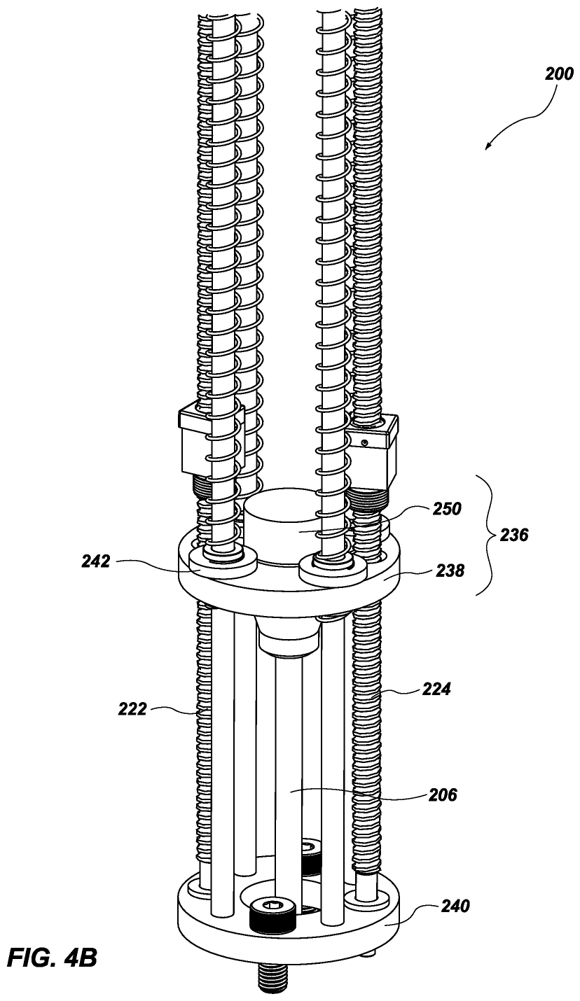

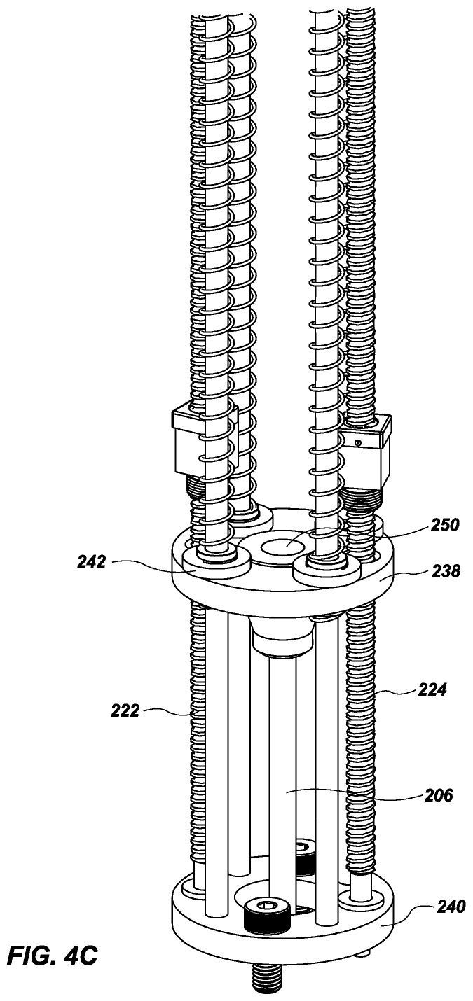

FIG. 4A is a perspective view of the quick release assembly 236 of the cage assembly 204 of the control rod drive system 200 according to one or more embodiments of the disclosure. FIG. 4B is a perspective view of the quick release assembly 236 of FIG. 4A with the drive platform 234 removed to better show the structure of the quick release assembly 236. FIG. 4C is a perspective view of the quick release assembly 236 of FIG. 4A with one or more portions of the quick release assembly 236 removed to better show the structure of the quick release assembly 236. Referring to FIGS. 4A-4C together, in some embodiments, the quick release assembly 236 may be operably coupled to the controller 201 and may include an electromagnet 250 and a correlating plate 252. The electromagnet 250 may be attached to the drive platform 234, and the plate 252 may be attached to the control platform 238. The electromagnet 250 may include a coil of wire through which a current may passed via the controller 201 to create a magnetic field. The plate 252 may include a ferromagnetic or ferrimagnetic material. For instance, the plate 252 may include one or more of iron, nickel, cobalt, or an alloy thereof.

Referring still to FIGS. 4A-4C, in operation, to couple the control platform 238 to the drive platform 234, the electromagnet 250 of the quick release assembly 236 may be energized (e.g., activated) to create a magnetic field and to attract the plate 252 to the electromagnet 250, thereby coupling the control platform 238 to the drive platform 234. Conversely, to release the control platform 238 from the drive platform 234, the electromagnet 250 of the quick release assembly 236 may be de-energized (e.g., deactivated) to remove the magnetic field and remove attraction between the plate 252 and the electromagnet 250, thereby releasing the control platform 238 from the drive platform 234.

Referring to FIGS. 1-4C together, during use, the control rod drive system 200 may be used to at least partially control operation of and/or shut down a nuclear reactor (e.g., nuclear reactor 102) by inserting the control rod 206 into or retracting the control rod 206 from a core 103 of the nuclear reactor 102. In some embodiments, the control rod 206 may be inserted into or retracted from the core 103 of the nuclear reactor 102 responsive to measured operating parameters (e.g., flux of the nuclear reactor, power output, steam production, etc.).

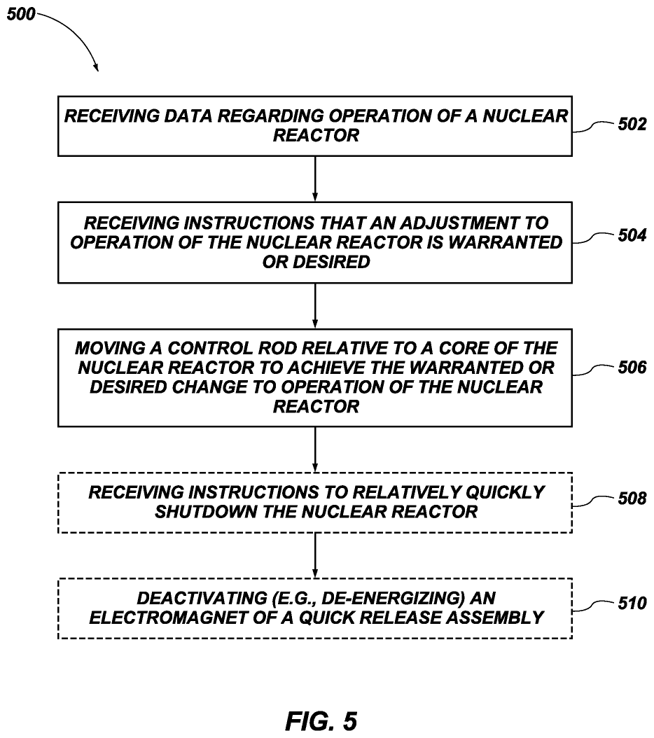

FIG. 5 is a flowchart of a method 500 of controlling operation of a nuclear reactor according to one or more embodiments of the disclosure. Referring to FIGS. 1-5 together, in some embodiments, the method 500 may include receiving data regarding operation of the nuclear reactor, as shown in act 502.

In some embodiments, the method 500 may include receiving instructions that an adjustment to operation of the nuclear reactor is warranted or desired, as shown in act 504 of FIG. 5. For example, in one or more embodiments, the controller 201 may receive instructions from one or more controllers of the nuclear reactor 102 that an adjustment to operation of the nuclear reactor is warranted or desired. In additional embodiments, the controller 201 itself may determine that an adjustment to operation of the nuclear reactor is warranted or desired based on conventional analyses of reactor operation.

The method 500 may further include, responsive to receiving the instructions that an adjustment to operation of the nuclear reactor is warranted or desired, moving the control rod 206 relative to a core of the nuclear reactor to achieve the warranted or desired change to operation of the nuclear reactor, as shown in act 506 of FIG. 5. In some embodiments, moving the control rod 206 may include causing the motor 208 to rotate the drive gear 210, which in turn causes the two receiving gears 212, 214 to rotate. As is discussed above, rotating the two receiving gears 212, 214 causes the two drive rods 222, 224 to rotate and causes the two drive blocks 230, 232 to translate along longitudinal lengths of the two drive rods 222, 224. As noted above, causing the two drive blocks 230, 232 to translate along longitudinal lengths of the two drive rods 222, 224 causes drive platform 234 to translate along longitudinal lengths of the two drive rods 222, 224 as well. Furthermore, when the quick release assembly 236 is coupling the control platform 238 to the drive platform 234, moving the drive platform 234 causes the control platform 238 to move in at least substantially the same manner. Therefore, moving the control rod 206 may include rotating the drive gear 210, while maintaining a coupling between the drive platform 234 and the control platform 238. For instance, moving the control rod 206 may include rotating the drive gear 210 while energizing the electromagnet 250 of the quick release assembly 236.

Depending on the warranted or desired change to operation of the nuclear reactor, moving the control rod 206 may include inserting the control rod 206 into or retracting the control rod 206 from the core 103 of the nuclear reactor 102. The control rod 206 may be inserted into the core 103 of the nuclear reactor 102 by rotating the drive gear 210 in a first direction and may be retracted by rotating the drive gear 210 in the second, opposite direction.

In some embodiments, the method 500 may optionally further include receiving instructions to relatively quickly shut down the nuclear reactor 102, as shown in act 508 of FIG. 5. For example, the controller 201 of the control rod drive system 200 may receive instructions related to quickly shutting down the nuclear reactor 102 from one or more controllers of the nuclear reactor 102. Alternatively, the controller 201 may receive one or more inputs from a reactor operator related to quickly shutting down the nuclear reactor 102.

Responsive to receiving instruction to relatively quickly shutdown the nuclear reactor 102, the method 500 may optionally include deactivating (e.g., de-energizing) the electromagnet 250 of the quick release assembly 236, as shown in act 510 of FIG. 5. Deactivating the electromagnet 250 removes the magnetic field generated by the electromagnet 250 and removes any attraction between the electromagnet 250, which is attached the drive platform 234, and the plate 252, which is attached to the control platform 238. Therefore, deactivating the electromagnet 250 releases the control platform 238 from the drive platform 234. Furthermore, as is discussed above, the control platform 238 may be coupled to the four drive springs 226, 228, 229, 231, which, upon the control platform 238 being released, may expand from a compressed state and may push the control platform 238 in a direction away from the upper platform 216 (e.g., down) and toward the core 103 of the nuclear reactor 102. Therefore, the four drive springs 226, 228, 229, 231 may push the control rod 206, which is coupled to the control platform 238, at least partially into the core 103 of the nuclear reactor 102. Moreover, upon the control platform 238 being released, in some embodiments, gravity may pull the control platform 238 downward and the control rod 206 into the nuclear reactor 102. Furthermore, inserting the control rod 206 into the nuclear reactor 102 may cause the nuclear reactor 102 to at least partially shut down or decrease reactive activity within the nuclear reactor 102.

In some embodiments, when the control platform 238 is released from the drive platform 234 via the quick release assembly 236 and while the control platform 238 is traveling along the four guide rods 218, 219, 220, 221 at a relatively high velocity, the bushings 242 may exhibit braking properties to slow the velocity of the control platform 238 and reduce the likelihood that the control platform 238 impacts the lower platform 240. For example, as noted above, in one or more embodiments, the bushings 242 may include permanent magnets or electromagnets, and as conductive surfaces of the four guide rods 218, 219, 220, 221 are moving past the bushings 242 (e.g., magnets), circular electric currents called eddy currents are generated within the conductive surfaces by the magnetic field emitted by the bushings 242. The circulating currents create their own magnetic fields that opposes the magnetic field of the bushings 242. Thus, the bushings 242 exhibit a drag force on the four guide rods 218, 219, 220, 221 that opposes the motion of the bushings 242, and the drag force may be proportional to the velocity of the bushings 242 (e.g., the velocity of the control platform 238). In view of the foregoing, in some embodiments, the bushings 242 reduce the likelihood that the control platform 238 impacts the lower platform 240 when the control platform 238 is released from the drive platform 234. Furthermore, the bushings 242 may prevent the control rod 206 from being inserted into the core 103 of the nuclear reactor 102 too quickly. Additionally, the bushings 242 may reduce wear and tear and prevent damage to the control rod drive system 200.

Referring to FIGS. 1-5 together, while the control drive system 100 is depicted in a general vertical orientation, the disclosure is not so limited. Rather, one of ordinary skill in the art will readily recognize from the disclosure that the control drive system 100 could be utilized in a horizontal orientation or a tilted orientation.

The control rod drive system 200 of the disclosure may provide advantages over conventional control rod drives systems. For instance, the control rod drive system 200 may be more appropriate for use in microreactors and being utilized in relatively small spaces or where weight allowances are relatively low. Moreover, the control rod drive system 200 can readily be adjusted in size and shape to accommodate a given space or configuration. For instance, an overall longitudinal length can be readily adjusted and/or the number of platforms can be adjusted. By having a flexible configuration, the control rod drive system 200 of the disclosure may provide additional space between sensitive electronics (e.g., the motor 208) and the core 103 of the nuclear reactor 102. Furthermore, additional platforms may provide additional shielding or may carry additional components (e.g., sensors) for monitoring reactor performance. Additionally, the control rod drive system 200 may be readily replaceable and may not require extensive disassembly for replacement. Furthermore, the control rod drive system 200 may enable separation between safety related (SR) components and non-safety related (NSR) components of the nuclear reactor 102, and therefore, may enable an efficient solution with potential to incorporate other technologies and systems without interfering with required capabilities. Moreover, the control rod drive system 200 exhibits and enables both active flux control via motors and drive rods and passive reactor shutdown or control via a quick release assembly. Furthermore, the lengths of the guide rods 218, 219, 220, 221 may be selected for radiation distancing of sensitive electronics from the core 103 and/or for thermal dissipation.

Additionally, the control rod drive system 200 provides a readily adaptable structure that is readily deployable in the variety of reactor (e.g., microreactor) configurations. Furthermore, the control rod drive system design provides a complete or near complete solution that can be relatively easily optimized and will accelerate the development of other designs as well as deployment. Moreover, the control rod drive system 200 provides efficient maintenance assurance (e.g., the control rod drive system 200 provides assurance that actuators and other elements can be readily replaced if needed\, and the control rod drive system 200 provides readily accessible components for general maintenance).

FIG. 6 is a block diagram of a controller 600 according to one or more embodiments of the present disclosure. The controller 600 may include the controller 201 described above. One will appreciate that one or more computing devices may implement the controller 600. The controller 600 can comprise a processor 602, a memory 604, a storage device 606, an I/O interface 608, and a communication interface 610, which may be communicatively coupled by way of a communication infrastructure. While an example of a computing device is shown in FIG. 6, the components illustrated in FIG. 6 are not intended to be limiting. Additional or alternative components may be used in other embodiments. Furthermore, in certain embodiments, the controller 600 can include fewer components than those shown in FIG. 6. Components of the controller 600 shown in FIG. 6 will now be described in additional detail.

In one or more embodiments, the processor 602 includes hardware for executing instructions, such as those making up a computer program. As an example and not by way of limitation, to execute instructions, the processor 602 may retrieve (or fetch) the instructions from an internal register, an internal cache, the memory 604, or the storage device 606 and decode and execute them. In one or more embodiments, the processor 602 may include one or more internal caches for data, instructions, or addresses. As an example and not by way of limitation, the processor 602 may include one or more instruction caches, one or more data caches, and one or more translation lookaside buffers (“TLBs”). Instructions in the instruction caches may be copies of instructions in the memory 604 or the storage device 606.

The memory 604 may be used for storing data, metadata, and programs for execution by the processor(s). The memory 604 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 604 may be internal or distributed memory.

The storage device 606 includes storage for storing data or instructions. As an example and not by way of limitation, storage device 606 can comprise a non-transitory storage medium described above. The storage device 606 may include a hard disk drive (“HDD”), a floppy disk drive, flash memory, an optical disc, a magneto-optical disc, magnetic tape, or a Universal Serial Bus (“USB”) drive or a combination of two or more of these. The storage device 606 may include removable or non-removable (or fixed) media, where appropriate. The storage device 606 may be internal or external to the controller 600. In one or more embodiments, the storage device 606 is non-volatile, solid-state memory. In other embodiments, the storage device 606 includes read-only memory (“ROM”). Where appropriate, this ROM may be mask programmed ROM, programmable ROM (“PROM”), erasable PROM (“EPROM”), electrically erasable PROM (“EEPROM”), electrically alterable ROM (“EAROM”), or flash memory or a combination of two or more of these.

The I/O interface 608 allows a user to provide input to, receive output from, and otherwise transfer data to and receive data from controller 600. The I/O interface 608 may include a mouse, a keypad or a keyboard, a touch screen, a camera, an optical scanner, network interface, modem, other known I/O devices or a combination of such I/O interfaces. The I/O interface 608 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 608 is configured to provide graphical data to a display for presentation to a user. The graphical data may be representative of one or more graphical user interfaces and/or any other graphical content as may serve a particular implementation.

The communication interface 610 can include hardware, software, or both. In any event, the communication interface 610 can provide one or more interfaces for communication (such as, for example, packet-based communication) between the controller 600 and one or more other computing devices or networks. As an example and not by way of limitation, the communication interface 610 may include a network interface controller (“NIC”) or network adapter for communicating with an Ethernet or other wire-based network or a wireless NIC (“WNIC”) or wireless adapter for communicating with a wireless network, such as a WI-FI.

Additionally or alternatively, the communication interface 610 may facilitate communications with an ad hoc network, a personal area network (“PAN”), a local area network (“LAN”), a wide area network (“WAN”), a metropolitan area network (“MAN”), or one or more portions of the Internet or a combination of two or more of these. One or more portions of one or more of these networks may be wired or wireless. As an example, the communication interface 610 may facilitate communications with a wireless PAN (“WPAN”) (such as, for example, a BLUETOOTH WPAN), a WI-FI network, a WI-MAX network, a cellular telephone network (such as, for example, a Global System for Mobile Communications (“GSM”) network), or other suitable wireless network or a combination thereof.

Additionally, the communication interface 610 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 612 may include hardware, software, or both that couples components of the controller 600 to each other. As an example and not by way of limitation, the communication infrastructure 612 may include an Accelerated Graphics Port (“AGP”) or other graphics bus, an Enhanced Industry Standard Architecture (“EISA”) bus, a front-side bus (“FSB”), a HYPERTRANSPORT (“HT”) interconnect, an Industry Standard Architecture (“ISA”) bus, an INFINIBAND interconnect, a low-pin-count (“LPC”) bus, a memory bus, a Micro Channel Architecture (“MCA”) bus, a Peripheral Component Interconnect (“PCI”) bus, a PCI-Express (“PCIe”) bus, a serial advanced technology attachment (“SATA”) bus, a Video Electronics Standards Association local (“VLB”) bus, or another suitable bus or a combination thereof.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and legal equivalents.

1. A control rod drive system, comprising:
a drive assembly; and
a cage assembly operably coupled to the drive assembly, the cage assembly comprising:
drive rods operably engaged with a drive platform;
guide rods extending through the drive platform; and
a control platform releasably coupled to the drive platform via a quick release assembly, the control platform configured to have a control rod mounted thereto.

2. The control rod drive system of claim 1, further comprising:
an upper platform to which upper longitudinal ends of the drive rods are mounted; and
drive springs extending between the upper platform and the control platform.

3. The control rod drive system of claim 2, wherein the drive springs are free relative to the drive platform.

4. The control rod drive system of claim 1, wherein the quick release assembly comprises:
an electromagnet attached to the drive platform; and
a plate comprising a ferromagnetic material attached to the control platform.

5. The control rod drive system of claim 1, wherein the drive assembly comprises:
a motor; and
a drive gear operably coupled to the motor and operably coupled to the drive rods.

6. The control rod drive system of claim 5, further comprising sun gears operably coupling the drive gear to the drive rods.

7. The control rod drive system of claim 1, further comprising a controller to which the drive assembly and the cage assembly are operably coupled.

8. The control rod drive system of claim 1, further comprising drive blocks, each of the drive blocks engaged within a respective drive rod of the drive rods and attached to the drive platform.

9. The control rod drive system of claim 1, further comprising bushings, each bushing being disposed between a respective guide rod and the control platform.

10. The control rod drive system of claim 9, wherein each bushing comprises a magnet.

11. The control rod drive system of claim 9, wherein at least one of the bushings or the guide rods include one or more magnets.

12. The control rod drive system of claim 1, wherein each drive rod comprises a threaded rod.

13. The control rod drive system of claim 12, wherein each of the drive rods is threaded in a same direction.

14. A nuclear reactor system, comprising:
a core;
a plurality of control rods for insertion into and retraction out of the core; and
a plurality of control rod drive systems, each of the control rod drive systems comprising:
a drive assembly; and
a cage assembly operably coupled to the drive assembly, the cage assembly comprising:
a plurality of drive rods operably engaged with a drive platform;
a plurality of guide rods extending through the drive platform; and
a control platform releasably coupled to the drive platform via quick release assembly, the control platform configured to have a respective control rod of the plurality of control rods mounted thereto.

15. The nuclear reactor system of claim 14, wherein each of the control rod drive systems further comprises:
an upper platform coupled to the plurality of drive rods; and
a plurality of drive springs extending between the upper platform and the control platform.

16. The nuclear reactor system of claim 15, wherein the plurality of drive springs are uncoupled from the drive platform.

17. The nuclear reactor system of claim 14, wherein the quick release assembly of each of the control rod drive systems comprises:
an electromagnet attached to one of the drive platform or the control platform; and
a plate comprising a ferromagnetic material attach to another of the drive platform or the control platform.

18. The nuclear reactor system of claim 14, wherein each of the control rod drive systems further comprises a plurality of bushings, each bushing of the plurality of bushings being disposed between a respective guide rod and the control platform.

19. A method of controlling operation of a nuclear reactor, the method comprising:
receiving instructions to adjust operation of the nuclear reactor;
moving a control rod relative to a core of the nuclear reactor via rotating one or more drive rods engaged with a drive platform; and
releasing a control platform coupled to the control rod from the drive platform.

20. The method of claim 19, wherein releasing the control platform comprises deactivating an electromagnet of a quick release assembly.
